(19) United States
(12) Patent Application Publication
(10) Pub. No.: US 2014/0097232 A1
(43) Pub. Date: Apr. 10, 2014

(54) BONDING METHOD AND PRODUCTION METHOD

(71) Applicant: Fujikura Ltd., Tokyo (JP)

(72) Inventors: Nozomu Toyohara, Sakura-shi (JP); Akira Sakamoto, Sakura-shi (JP); Yohei Kasai, Sakura-shi (JP)

(73) Assignee: FUJIKURA LTD., Tokyo (JP)

(21) Appl. No.: 14/103,050

(22) Filed: Dec. 11, 2013

Related U.S. Application Data
(63) Continuation of application No. PCT/JP2012/059153, filed on Apr. 4, 2012.

(30) Foreign Application Priority Data
Jun. 16, 2011 (JP) 2011-134549

(51) Int. Cl. B23K 1/00

(52) U.S. Cl. CPC B23K 1/00
USPC 228/256; 228/101

(57) ABSTRACT

A bonding method of the present invention is a method of bonding two members (A and B) to each other with use of an Au—Sn solder. According to the bonding method of the present invention, after the bonding, an Au—Sn solder (S′) has weight percent of Sn which is not less than 38.0 wt % but not more than 82.3 wt %.

### CROSS-REFERENCE TO RELATED APPLICATIONS

This application is a Continuation of PCT International Application No. PCT/JP2012/059153 filed in Japan on Apr. 4, 2012, which claims the benefit of Patent Application No. 2011-134549 filed in Japan on Jun. 16, 2011, the entire contents of which are hereby incorporated by reference.

### TECHNICAL FIELD

The present invention relates to (i) a bonding method of bonding two members to each other with use of a solder and (ii) a method of producing a laser module by use of the bonding method.

### BACKGROUND ART

Laser modules are in widespread use as a device for causing laser to enter an optical fiber. A laser module is provided with (i) a laser light source for emitting laser, (ii) an optical fiber for receiving the laser and (iii) a heat radiation substrate to which the laser light source and the optical fiber are attached. The laser light source and the optical fiber are fixed to the heat radiation substrate in such a manner that laser emitted by the laser light source efficiently enters the optical fiber.

According to a typical laser module, a laser light source and an optical fiber are not directly bonded to a heat radiation substrate, but a laser mount and a fiber mount are bonded to the heat radiation substrate, and then the laser light source and the optical fiber are bonded to the laser mount and the fiber mount, respectively. These members are frequently bonded to each other with use of a solder such as a 90Sn-10Au solder (gold-tin solder) or an 80Au-20Sn solder. Patent Literature 1 is an example document which discloses the optical fiber thus configured above.

Patent Literature 2 discloses a method of, without remelting a solder which has been already used to bond members, bonding in sequence a plurality of members, which constitute a laser module, with use of an Au—Sn solder having weight percent of Sn of not more than 13 wt %.

### CITATION LIST

### Patent Literatures

Patent Literature 1
U.S. Pat. No. 6,758,610, specification (Registration Date: Jun. 6, 2004)

Patent Literature 2
Japanese Patent Application Publication, Tokukai, No. 2003-200289 A (Publication Date: Jul. 15, 2003)

### SUMMARY OF INVENTION

### Technical Problem

However, the above-described Au—Sn solders have the following problems.

The melting point of an 80Au-20Sn solder is as high as 278° C. Therefore, use of the 80Au-20Sn solder for bonding of a member causes the member to be thermally bent. Therefore, the 80Au-20Sn solder is not suitable for bonding of a member, such as a semiconductor laser chip, which is vulnerable to thermal bending. The melting point of the Au—Sn solder described in Patent Literature 2 is not less than 300° C., and therefore the Au—Sn solder is much less suitable for bonding of such a member which is vulnerable to thermal bending.

The melting point of a 90Sn-10Au solder is 217° C., and the 90Sn-10Au solder is frequently used to bond a semiconductor laser chip. However, the 90Sn-10Au solder is a soft solder having a small Young's modulus, and therefore has a problem of easily reducing an accuracy of a location where a member is bonded with use of the 90Sn-10Au solder.

The present invention was made in view of the problems, and an object of the present invention is to realize a bonding method which allows an Au—Sn solder, such as a 90Sn-10Au solder, to serve as a hard solder after being used to bond members to each other.

### Solution to Problem

In order to attain the object, a bonding method of the present invention is arranged to be a method of bonding a first member to a second member with use of an Au—Sn solder, wherein: after the bonding, the Au—Sn solder has weight percent of Sn which is not less than 38.0 wt % but not more than 82.3 wt %.

According to the arrangement, after the bonding, the Au—Sn solder becomes (i) a hard solder containing a eutectic of ε-AuSn and η-AuSn (in a case where, after the bonding, the Au—Sn solder has weight percent of Sn which is not less than 55.0 wt % but not more than 82.3 wt %) or (ii) a hard solder containing a eutectic of δ-AuSn and ε-AuSn (in a case where, after the bonding, the Au—Sn solder has weight percent of Sn which is not less than 38.0 wt % but not more than 61.0 wt %). Further, by using in combination an Au layer formed on a bonded surface of the first member or the second member, it is possible to employ an Au—Sn solder, such as a 90Sn-10Au solder, as a hard solder after the bonding.

### Advantageous Effects of Invention

According to the present invention, it is possible to employ an Au—Sn solder, such as a 90Sn-10Au solder, as a hard solder after bonding.

### BRIEF DESCRIPTION OF DRAWINGS

FIG. 1 is a cross-sectional view illustrating (i) an Au—Sn solder and (ii) how each of two members to be bonded to each other with use of the Au—Sn solder is configured. (a) of FIG. 1 illustrates the two members which have not been bonded to each other. (b) of FIG. 1 illustrates the two members which have been bonded to each other.

FIG. 2 is a view (phase diagram) illustrating a state of the Au—Sn solder.

FIG. 3 is a perspective view illustrating an entire semiconductor laser module produced by a production method which employs a bonding method illustrated in FIG. 1.

FIG. 4 is a view schematically illustrating the production method of producing the semiconductor laser module illustrated in FIG. 3.

### DESCRIPTION OF EMBODIMENTS

### Summary of Bonding Method

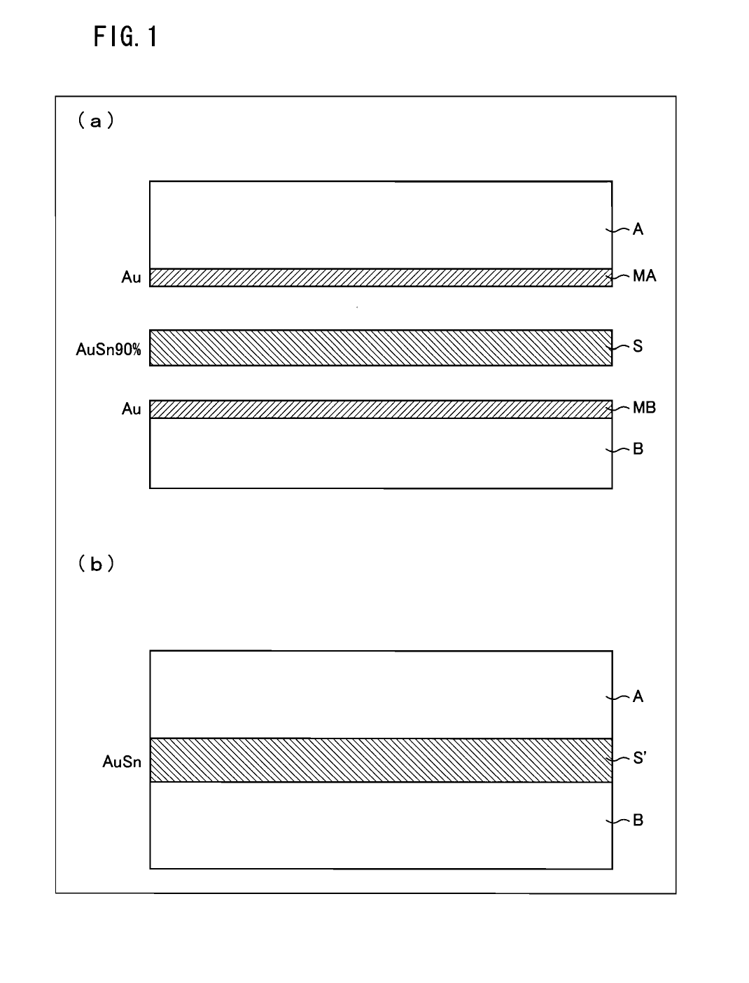

The following description will discuss, with reference to FIG. 1, a bonding method in accordance with an embodiment of the present invention. According to the bonding method of the present embodiment, a member A and a member B are bonded to each other with use of an Au—Sn (gold-tin) solder S.

Note that each of the members A and B to be bonded to each other merely needs to have at least one (1) flat surface. In this case, such flat surfaces (hereinafter referred to as “bonded surfaces”) are bonded to each other via the Au—Sn solder S by use of the bonding method of the present embodiment. A material for each of the members A and B is not limited to a specific one. It is, however, assumed in the present embodiment that the material for each of the members A and B is a material, such as AlN (aluminum nitride) or CuW (copper tungsten), which is frequently used in an optical device such as a laser module.

(a) of FIG. 1 is a cross-sectional view illustrating the members A and B which have not been bonded to each other.

As illustrated in (a) of FIG. 1, (i) the member A has a bonded surface on which an Au layer MA is formed and (ii) the member B has a bonded surface on which an Au layer MB is formed. The Au layers MA and MB are formed on the respective bonded surfaces by means of, for example, plating or vapor deposition, and are sometimes called “metalized”.

The Au—Sn solder S is a 90Sn-10Au solder in the shape of a plate. The melting point of Au—Sn solder S is 217° C. The Au—Sn solder S is frequently used to bond a member, such as a semiconductor laser, which is vulnerable to thermal stress.

The members A and B are bonded to each other with use of the Au—Sn solder S by heating the member B by use of, for example, a heater stage while (i) the bonded surface of the member A is coming into contact with one of main surfaces of the Au—Sn solder S and (ii) the bonded surface of the member B is coming into contact with the other of the main surfaces. Heat, which has been conducted from the heater stage to the member B, is further conducted to the Au—Sn solder S. This causes an increase in temperature of the Au—Sn solder S.

When the temperature of the Au—Sn solder S exceeds the melting point 217° C., the Au—Sn solder S melts, and Au, contained in the Au layers MA and MB, is diffused into the Au—Sn solder S which has melted. This causes the Au—Sn solder S″ (not illustrated), which has melted, to have weight percent of Sn smaller than that of the Au—Sn solder S which has not been used to bond the members A and B. This is because a rate of Sn to the whole Au—Sn solder S″ is reduced by an increase in amount of Au. Such an increase is due to the fact that Au, contained in the Au layers MA and MB, has been diffused into the Au—Sn solder S″.

By cooling the Au—Sn solder S″, it is possible to form (i) a eutectic of η-AuSn and β-Sn, (ii) a eutectic of ε-AuSn and η-AuSn, or (iii) a eutectic of ε-AuSn and δ-AuSn. Whether the eutectic (i), (ii), or (iii) is formed depends on the weight percent of Sn in the Au—Sn solder S″. In a case where the Au—Sn solder S″ is further quickly cooled, the Au—Sn solder S″ is solidified while it is maintaining a composition of one of the eutectics (i) through (iii). Thus, the bonding of the members A and B is completed. Note that which one of the eutectics (i) through (iii) is formed by cooling the Au—Sn solder S″, will be described later with reference to another drawing.

(b) of FIG. 1 is a cross-sectional view illustrating the members A and B which have been bonded to each other.

As illustrated in (b) of FIG. 1, the members A and B are bonded to each other via the Au—Sn solder S′ which has been used to bond the member A to the member B, in a case where all Au, contained in the Au layers MA and MB, is diffused in the Au—Sn solder S″. After the bonding of the members A and B, the Au—Sn solder S′ has weight percent of Sn which is (i) equal to that of the Au—Sn solder S″ and (ii) smaller than that of the Au—Sn solder S which has not been used to bond the members A and B.

In the case where the all Au contained in the Au layers MA and MB is diffused in the Au—Sn solder S″ which is in a molten state, weight percent P′ of Sn in the Au—Sn solder S′ is calculated as follows: P′=100×x/(x+y) where (i) x represents mass of Sn contained in the Au—Sn solder S, (ii) yS represents mass of Au contained in the Au—Sn solder S, (iii) yMA represents mass of Au contained in the Au layer MA, (iv) yMB represents mass of Au contained in the Au layer MB, and (v) y represents the total of yS, yMA, and yMB.

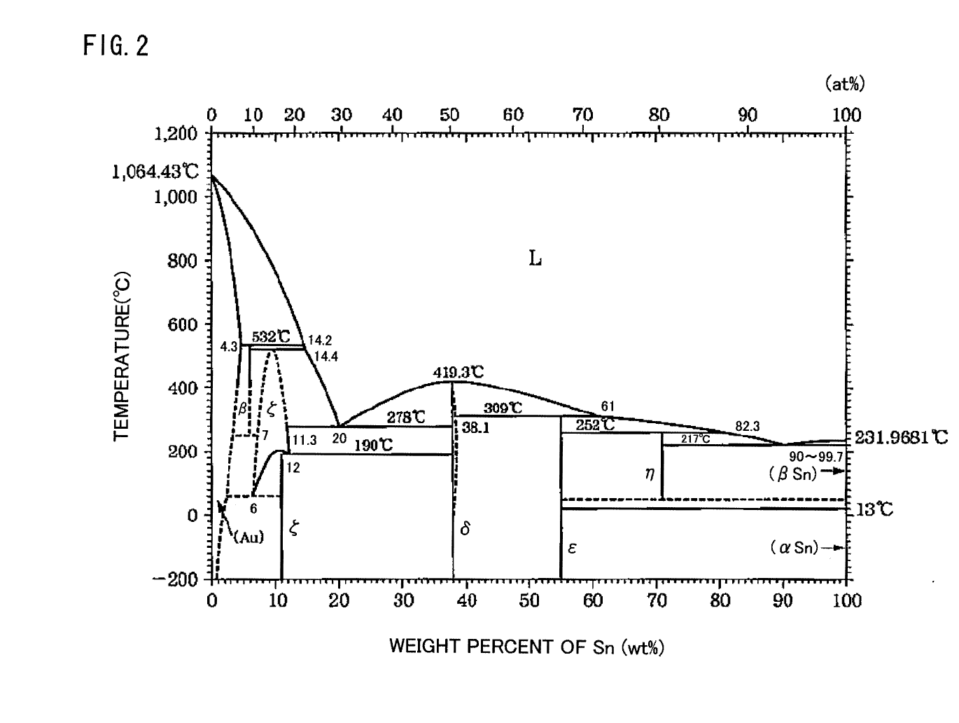

The following description will discuss the physical property of the Au—Sn solder S′ with reference to FIG. 2. FIG. 2 is a view (phase diagram) illustrating a state of an Sn—Au alloy. In the phase diagram of FIG. 2, the horizontal axis represents weight percent of Sn (wt %), and the vertical axis represents temperature)(C°).

The melting point of the Au—Sn solder S′ will be described below with reference to FIG. 2.

The melting point of the Au—Sn solder S′ varies depending on the weight percent of Sn in the Au—Sn solder S′. Specifically, in a case where the weight percent of Sn in the Au—Sn solder S′ is not less than 38 wt %, the melting point of the Au—Sn solder S′ increases as the weight percent of Sn in the Au—Sn solder S′ decreases (see FIG. 2). As has been described, the weight percent of Sn in the Au—Sn solder S′ is smaller than that in the Au—Sn solder S. It follows that the melting point of the Au—Sn solder S′ is higher than that of the Au—Sn solder S.

Such a physical property of the Au—Sn solder S′ is remarkably suitable for bonding of members. For example, in a case where a member B is bonded to a member A via the Au—Sn solder S′, and then a member C is bonded to the member B via the Au—Sn solder S, the melting point of the Au—Sn solder S′ via which the members A and B have been bonded to each other is higher than the melting point 217° C. of the Au—Sn solder S via which the members B and C are to be bonded to each other. Even in a case where the member B is heated to 217° C. so that the Au—Sn solder S between the members B and C is melted, the Au—Sn solder S′ between the members A and B will never be melted.

A eutectic composition of the Au—Sn solder S′ will be described below with reference to FIG. 2.

As is clear from FIG. 2, in a case where the Au—Sn solder S″ has weight percent of Sn which is not less than 82.3 wt % but not more than 90.0 wt %, the Au—Sn solder S′ forms (i) a eutectic of η-AuSn and β-Sn. In a case where the Au—Sn solder S″ has weight percent of Sn which is not less than 55.0 wt % but not more than 82.3 wt %, the Au—Sn solder S′ contains (ii) a eutectic of ε-AuSn and η-AuSn. In a case where the Au—Sn solder S″ has weight percent of Sn which is not less than 38.0 wt % but not more than 61.0 wt %, the Au—Sn solder S′ contains (iii) a eutectic of 6-AuSn and ε-AuSn.

Note that ε-AuSn has a Young's modulus 103 GPa that is higher than each of a Young's modulus (40 GPa) of a 90Sn-10Au solder and a Young's modulus (41.4 GPa) of β-Sn. δ-AuSn has a Young's modulus of 87±9 GPa that is higher than each of the Young's modulus of the 90Sn-10Au solder and the Young's modulus of β-Sn. By causing the Au—Sn solder S″ to have weight percent of Sn which is not less than 38.0 wt % but not more than 82.3 wt %, it is therefore possible for a 90Sn-10Au solder, which originally serves as a soft solder, to serve as a hard solder having a Young's modulus approximately twice higher than that of the 90Sn-10Au solder.

Such a physical property of the Au—Sn solder S′ is also remarkably suitable for bonding of members. It is possible for a bonding strength to vary from bonded part to bonded part, by changing as appropriate a thickness of an Au layer formed on a surface of a member to be bonded. For example, it is possible for an Au—Sn solder to serve as a soft solder by reducing a thickness of an Au layer in a bonded part where a stress should be reduced. In contrast, it is possible for an Au—Sn solder to serve as a hard solder by increasing a thickness of an Au layer in bonded part where members should be securely bonded to each other.

Note that a condition, which allows an Au—Sn solder S to serve as a hard solder, can be expressed by 0.380≦x/(x+y)≦0.823, where (i) x represents mass of Sn contained in the Au—Sn solder S which has not been used to bond the members, (ii) yS represents mass of Au contained in the Au—Sn solder S which has not been used to bond the members, (iii) yMA represents mass of Au contained in an Au layer MA, (iv) yMB represents mass of Au contained in an Au layer MB, and (v) y represents the total of yS, yMA, and yMB.

### Application Example

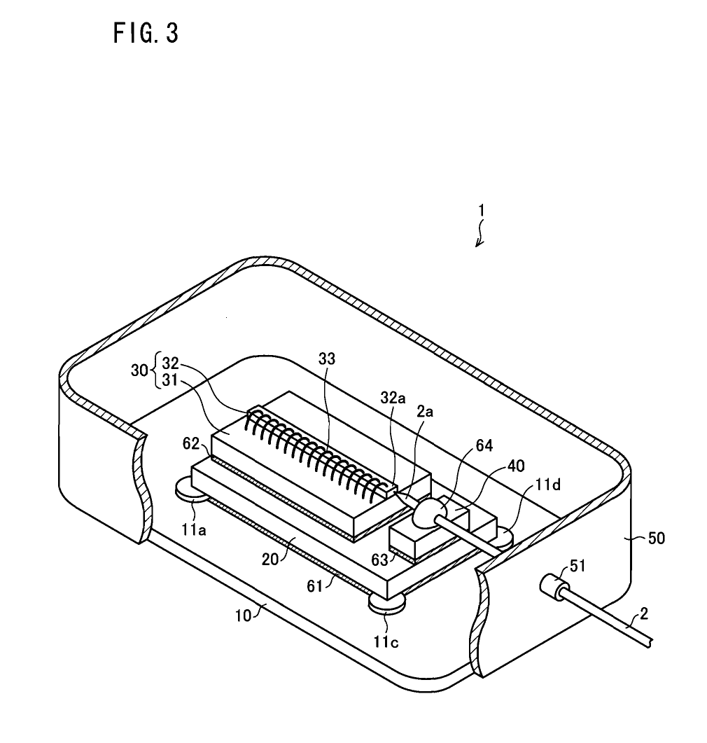

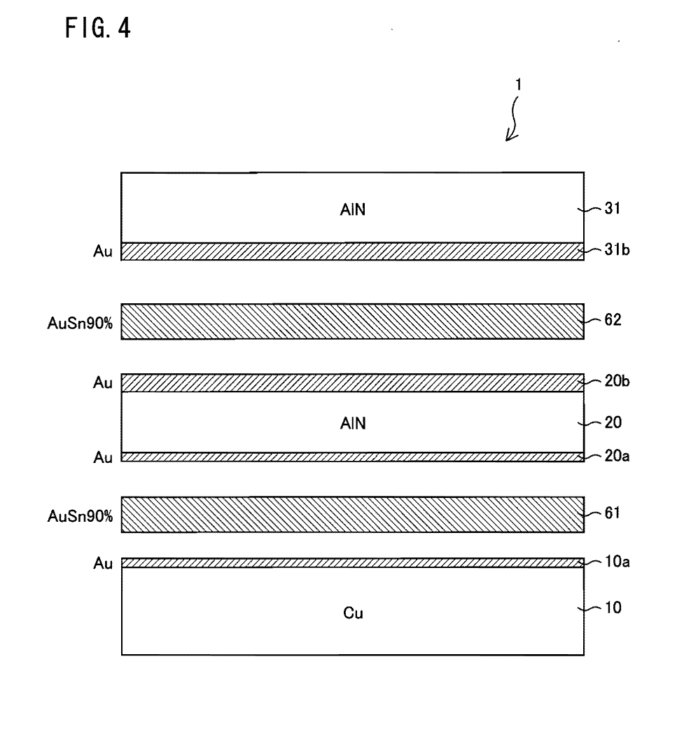

The following description will discuss, with reference to FIGS. 3 and 4, an application example of the bonding method of the present embodiment.

The following description will discuss how a semiconductor laser module 1 is configured, with reference to FIG. 3, which semiconductor laser module 1 is produced by use of the bonding method of the present embodiment. FIG. 3 is a perspective view illustrating the entire semiconductor laser module 1 produced by use of the bonding method of the present embodiment.

The semiconductor laser module 1 is to be attached to an end part of an optical fiber 2. As illustrated in FIG. 3, the semiconductor laser module 1 includes a substrate 10, a submount 20, a CoS (Chip on Submount) 30, a fiber mount 40, and a case 50. Note that FIG. 3 does not illustrate a top board of the case 50 and part of a side board of the case 50 so as to reveal an inner structure of the semiconductor laser module 1.

Note that the substrate 10 is a bottom plate of the semiconductor laser module 1. According to the present application example, a plate-like member with round corners, which has a main surface in the shape of a rectangle, is employed as the substrate 10 (see FIG. 3). The substrate 10 serves as a heat sink via which heat generated in the semiconductor laser module 1 (particularly, in the CoS 30) is radiated outside of the semiconductor laser module 1. Because of this, the substrate 10 is made from a material, such as Cu (copper), which has a high thermal conductivity.

The substrate 10 has an upper surface on which four protrusions 11a through 11d are provided (see FIG. 3). The protrusions 11a through 11d each serve as spacer by which a lower surface of the submount 20 is kept away from the upper surface of the substrate 10. The protrusions 11a through 11d are each formed by means of a process, such as a punching process or a cutting process, so as to be integrated with the substrate 10.

The submount 20 is provided above the upper surface of the substrate 10 (see FIG. 3).

The submount 20 is a support member which supports the CoS 30 and the fiber mount 40. According to the present application example, a plate-like member, which has a main surface in the shape of a rectangle, is employed as the submount 20. The submount 20 is arranged so as to have (i) the lower surface parallel to the upper surface of the substrate 10 and (ii) the main surface whose long side is parallel to that of the main surface of the substrate 10 (see FIG. 3). The lower surface of the submount 20 is bonded to the upper surface of the substrate 10, via a soft solder 61 which is spread between the lower surface of the submount 20 and the upper surface of the substrate 10. A 90Sn-10Au solder is employed as the soft solder 61 (later described) in a case where the submount 20 and the substrate 10 are bonded to each other.

The CoS 30 and the fiber mount 40 are provided on an upper surface of the submount 20 (see FIG. 3). Specifically, (i) the fiber mount 40 is provided on a first side (on a side closer to a right periphery of FIG. 3, which is hereinafter referred to as “on a fiber side”) of the upper surface of the submount 20, from which first side the optical fiber 2 is drawn outside of the semiconductor laser module 1 and (ii) the CoS 30 is provided on a second side (on a side closer to a left periphery of FIG. 3, which is hereinafter referred to as a “on a lead side”) of the upper surface of the submount 20, which second side is opposite to the first side.

The CoS 30 is formed so that a laser mount 31 is integrated with a semiconductor laser chip 32.

The laser mount 31 is a support member which supports the semiconductor laser chip 32. According to the present application example, a plate-like member, which has a main surface in the shape of a rectangle, is employed as the laser mount 31. The laser mount 31 is provided so that (i) its lower surface is parallel to the upper surface of the submount 20 and (ii) a long side of the main surface is parallel to that of the main surface of the submount 20 (see FIG. 3). The lower surface of the laser mount 31 is bonded to the upper surface of the submount 20, via a hard solder 62 which is spread between the lower surface of the laser mount 31 and the upper surface of the submount 20. A 90Sn-10Au solder is employed as the hard solder 62 (later described) to bond the laser mount 31 to the submount 20.

The semiconductor laser chip 32 is provided on an upper surface of the laser mount 31 (see FIG. 3). The semiconductor laser chip 32 is a laser light source for emitting laser beams from an end surface 32a of the semiconductor laser chip 32. According to the present application example, a high-power semiconductor laser, which (i) is mainly made from GaAs (gallium arsenide) and (ii) has a cavity length of not shorter than 5 mm, is employed as the semiconductor laser chip 32. The semiconductor laser chip 32 is provided so as to extend in a direction parallel to the long side of the main surface of the laser mount 31. The semiconductor laser chip 32 has a lower surface which is bonded to the upper surface of the laser mount 31 (see FIG. 3). Furthermore, the semiconductor laser chip 32 is connected, via a wire 33 (see FIG. 3), to a circuit (not illustrated) which is provided on the upper surface of the laser mount 31. The semiconductor laser chip 32 is driven by an electric current supplied from the circuit.

The fiber mount 40 is a support member which supports the optical fiber 2. According to the present application example, a plate-like member, which has a main surface in the shape of a rectangle, is employed as the fiber mount 40. The fiber mount 40 is provided so that (i) its lower surface is parallel to the submount 20 and (ii) a long side of the main surface is perpendicular to that of the main surface of the submount 20 (see FIG. 3). The lower surface of the fiber mount 40 is bonded to the upper surface of the submount 20, via a hard solder 63 which is spread between the lower surface of the fiber mount 40 and the upper surface of the submount 20.

The optical fiber 2, which is pulled in the semiconductor laser module 1 through a pipe 51 that is formed in the case 50, is provided on the fiber mount 40 (see FIG. 3). Specifically, the optical fiber 2 is (i) provided so that a tip 2a of the optical fiber 2, which tip 2a is formed in the shape of a wedge, faces right in front the end surface 32a of the semiconductor laser chip 32 and (ii) bonded onto an upper surface of the fiber mount 40 via a solder 64. Laser beams, which are emitted from the end surface 32a of the semiconductor laser chip 32, enter the tip 2a of the optical fiber 2, and then travel in the optical fiber 2.

The following description will discuss, with reference to FIG. 4, a production method of producing the semiconductor laser module 1, which production method employs the bonding method of the present embodiment. Note that what will be particularly focused on is (i) a step of bonding the submount 20 to the substrate 10 and (ii) a step of bonding the laser mount 31 to the submount 20 in the production method.

The step of bonding the lower surface of the laser mount 31 to the upper surface of the submount 20 will be first described below.

Before bonding the laser mount 31 to the submount 20, an Au layer 31b and an Au layer 20b are formed on the lower surface of the laser mount 31 and the upper surface of the submount 20, respectively (see FIG. 4). Each thickness of the Au layers 31b and 20b is determined so that 0.380≦x/(x+y)≦0.823 is satisfied, where (i) x represents mass of Sn contained in an Au—Sn solder 62 which is a 90Sn-10Au solder and which has not been used to bond the laser mount 31 to the submount 20, (ii) y62 represents mass of Au contained in the Au—Sn solder 62, (iii) y31b represents mass of Au contained in the Au layer 31b, (iv) y20b represents mass of Au contained in the Au layer 20b, and (v) y represents the total of y62, y31b, and y20b. In this case, as has been described with reference to FIG. 2, the Au—Sn solder 62 serves as a hard solder after being used to bond the laser mount 31 to the submount 20. Note that a plate-like 90Sn-10Au solder is employed as the Au—Sn solder 62.

After the Au layers 31b and 20b are thus formed, the laser mount 31 and the submount 20 are bonded to each other by carrying out the following steps S1 through S7.

Step S1: The submount 20 is provided on a heater stage.

Step S2: The Au—Sn solder 62 in the shape of a plate is provided on the submount 20.

Step S3: The laser mount 31 is provided on the Au—Sn solder 62.

Step S4: The submount 20 starts to be heated by use of the heater stage.

By carrying out the step S4, a temperature of the submount 20 is gradually increased. When the temperature of the submount 20 reaches 217° C., the Au—Sn solder 62 starts to melt from a submount 20 side. This causes the Au contained in the Au layers 31b and 20b to be diffused into the Au—Sn solder 62 which has melted. In consequence, weight percent of Sn of the Au—Sn solder 62 which has melted becomes not less than 38.0 wt % but not more than 82.3 wt %. Note that, in order to promote the diffusion of the Au, it is preferable to heat the Au—Sn solder 62 to a temperature as high as possible, but to such a degree as the temperature does not adversely affect the semiconductor laser chip 32. Specifically, it is preferable to heat the Au—Sn solder 62 up to approximately a temperature which falls within a range from 240° C. to 250° C.

Step S5: After the Au—Sn solder 62 has completely melted, the laser mount 31 is scrubbed. Note that what is meant by “the laser mount 31 is scrubbed” is “the laser mount 31 is slid, more than once, on a surface parallel to the upper surface of the submount 20”. This causes gas bubbles, mixed in between the Au—Sn solder 62 and the laser mount 31, to be eliminated.

Step S6: The heating of the submount 20 by the heater stage is stopped. This causes a gradual decrease in the temperature of the submount 20.

Step S7: the Au—Sn solder 62 is rapidly cooled. Since the Au—Sn solder 62 which has melted has the weight percent of Sn which is not less than 38.0 wt % but not more than 82.3 wt %, a eutectic of ε-AuSn and η-AuSn or a eutectic of 6-AuSn and ε-AuSn is formed.

Thus, the bonding of the laser mount 31 and the submount 20 is achieved. After being used to bond the laser mount 31 and the submount 20 to each other, the Au—Sn solder 62 serves as a hard solder having a larger Young's modulus.

The step of bonding the lower surface of the submount 20 to the upper surface of the substrate 10 will be described below. Note that the step of bonding the submount 20 to the substrate 10 is carried out after the step of bonding the laser mount 31 to the submount 20.

Before bonding the submount 20 to the substrate 10, an Au layer 20a and an Au layer 10a are formed on the lower surface of the submount 20 and the upper surface of the substrate 10, respectively. Each thickness of the Au layers 20a and 10a is determined so that 0.823≦x/(x+y)≦0.900 is satisfied, where (i) x represents mass of Sn contained in an Au—Sn solder 61 which has not been used to bond the submount 20 to the substrate 10, (ii) y61 represents mass of Au contained in the Au—Sn solder 61, (iii) y20a represents mass of Au contained in the Au layer 20a, (iv) y10a represents mass of Au contained in the Au layer 10a, and (v) y represents the total of y61, y20a, and y10a. In this case, as has been described with reference to FIG. 2, the Au—Sn solder 61 serves as a soft solder after being used to bond the submount 20 to the substrate 10. Note that a plate-like 90Sn-10Au solder is employed as the Au—Sn solder 61.

After the Au layers 20a and 10a are thus formed, the submount 20 is bonded to the substrate 10 by carrying out the following steps T1 through T7.

Step T1: The substrate 10 is provided on a heater stage.

Step T2: The Au—Sn solder 61 in the shape of a plate is provided on the substrate 10.

Step T3: The submount 20 is provided on the Au—Sn solder 61.

Step T4: The substrate 10 starts to be heated by use of the heater stage.

By carrying out the step T4, a temperature of the substrate 10 is gradually increased. When the temperature of the substrate 10 reaches 217° C., the Au—Sn solder 61 starts to melt from a substrate 10 side. This causes the Au contained in the Au layers 20a and 10a to be diffused into the Au—Sn solder 61 which has melted. In consequence, weight percent of Sn of the Au—Sn solder 61 which has melted becomes not less than 82.3 wt % but not more than 90.0 wt %.

Step T5: After the Au—Sn solder 61 has complet ely melted, the submount 20 is scrubbed.

Step T6: The heating of the substrate 10 by the heater stage is stopped. This causes a gradual decrease in the temperature of the substrate 10.

Step T7: The Au—Sn solder 61 is rapidly cooled. Since the Au—Sn solder 61 has the weight percent of Sn which is not less than 82.3 wt % but not more than 90.0 wt %, a eutectic of η-AuSn and β-Sn is formed.

Thus, the bonding of the submount 20 and the substrate 10 is achieved. After being used to bond the submount 20 and the substrate 10 to each other, the Au—Sn solder 61 serves as a soft solder having a smaller Young's modulus.

[Summary]

The bonding method of the present embodiment is thus arranged to be a method of bonding a first member to a second member with use of an Au—Sn solder, wherein: after the bonding, the Au—Sn solder has weight percent of Sn which is not less than 38.0 wt % but not more than 82.3 wt %.

According to the arrangement, after the bonding, the Au—Sn solder becomes (i) a hard solder containing a eutectic of ε-AuSn and η-AuSn (in a case where, after the bonding, the Au—Sn solder has weight percent of Sn which is not less than 55.0 wt % but not more than 82.3 wt %) or (ii) a hard solder containing a eutectic of 6-AuSn and ε-AuSn (in a case where, after the bonding, the Au—Sn solder has weight percent of Sn which is not less than 38.0 wt % but not more than 61.0 wt %). Further, by using in combination an Au layer formed on a first bonded surface of the first member or a second bonded surface of the second member, it is possible to employ a 90Sn-10Au solder as a hard solder after the bonding.

It is preferable to arrange the bonding method of the present embodiment such that, before the bonding, the Au layer is formed on at least one of (i) the first bonded surface of the first member and (ii) the second bonded surface of the second member, and 0.380≦x/(x+y)≦0.823 is satisfied where (i) x represents mass of Sn contained in the Au—Sn solder before the bonding and (ii) y represents total of mass of Au contained in the Au—Sn solder before the bonding and mass of Au contained in the Au layer.

According to the arrangement, it is possible to easily employ a 90Sn-10Au solder as a hard solder after the bonding, just by adjusting, for example, a thickness of the Au layer so that the mass of the Au contained in the Au layer satisfies the above condition.

It is preferable to arrange the bonding method of the present embodiment such that, before the bonding, the Au—Sn solder is a 90Sn-10Au solder.

According to the arrangement, it is possible to realize a hard solder by employing the 90Sn-10Au solder which is in widespread use.

Note that the present embodiment encompasses a method of producing a laser module, the method including the step of bonding by use of the bonding method.

[Additional Description]

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The present invention is widely applicable to bonding of members with use of an Au—Sn solder (such as a 90Sn-10Au solder). The present invention is widely applicable particularly to bonding of an optical member with use of the 90Sn-10Au solder.

### REFERENCE SIGNS LIST

A: member (first member)
MA: Au layer
B: member (second member)
MB: Au layer
S: Au—Sn solder (which has not been used to bond the members to each other) (90Sn-10Au solder)
S′: Au—Sn solder (which has been used to bond the members to each other)
1: semiconductor laser module (laser module)
10: substrate
11a through 11d: protrusion
20: submount
30: CoS
31: laser mount
32: semiconductor laser chip (laser light source)
40: fiber mount
50: case
61: soft solder
62: hard solder

1. A method of bonding a first member to a second member with use of an Au—Sn solder, wherein:
after the bonding, the Au—Sn solder has weight percent of Sn which is not less than 38.0 wt % but not more than 82.3 wt %.

2. The method as set forth in claim 1, comprising the steps of:
before the bonding, forming an Au layer on at least one of (i) a first bonded surface of the first member and (ii) a second bonded surface of the second member; and
melting the Au—Sn solder which is in contact with the first bonded surface and the second bonded surface,
0.380≦x/(x+y)≦0.823 being satisfied where (i) x represents mass of Sn contained in the Au—Sn solder before the bonding and (ii) y represents total of mass of Au contained in the Au—Sn solder before the bonding and mass of Au contained in the Au layer.

3. The method as set forth in claim 1, wherein:
before the bonding, the Au—Sn solder has weight percent of Sn which is more than 82.3 wt %.

4. The method as set forth in claim 3, wherein:
before the bonding, the Au—Sn solder is a 90Sn-10Au solder.

5. The method as set forth in claim 1, wherein:
after the bonding, the Au—Sn solder has weight percent of Sn which is not less than 55.0 wt % but not more than 82.3 wt %.

6. The method as set forth in claim 1, wherein:
after the bonding, the Au—Sn solder has weight percent of Sn which is not less than 38.0 wt % but not more than 61.0 wt %.

7. A method of producing a laser module which includes (i) a substrate, (ii) a submount provided on the substrate, (iii) a laser mount provided on the submount and (iv) a laser light source provided on the laser mount,
the method comprising the step of:
bonding the laser mount to the submount via the Au—Sn solder by use of a method recited in claim 1.
